(19) United States
(12) Patent Application Publication
(10) Pub. No.: US 2005/0074095 A1
(43) Pub. Date: Apr. 7, 2005

(54) Film positioning device

(76) Inventors: Wei-Chih Chang, Sindian City (TW); Wei-Chian Wang, Sindian City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/761,778

(22) Filed: Jan. 21, 2004

(30) Foreign Application Priority Data
Oct. 1, 2003 (TW) 92127235
Oct. 22, 2003 (CN) 200310102903.2

(51) Int. Cl. G03B 42/02; H05G 1/08

(52) U.S. Cl. 378/176; 378/172; 378/91; 378/98

(57) ABSTRACT

A film positioning device for detection a position of a contact point. The film positioning device includes an X film having a first X terminal and a second X terminal, a Y film having a first Y terminal and a second Y terminal, a first Y switch coupled between the first Y terminal and a ground, a second Y switch coupled between a second Y terminal and a power source, a first X switch coupled between the first X terminal and the ground, a second X switch coupled between the second X terminal and the power source, a first X capacitor coupled between the first X terminal and the second X terminal, and a second Y capacitor coupled between the first Y terminal and the second Y terminal.

This application claims the benefit of Taiwan application Serial No. 92127235, filed Oct. 01, 2003.

### BACKGROUND OF THE INVENTION

1. Field of the Invention

The invention relates to a film positioning device, and more particularly to a film positioning device having a quick response speed.

2. Description of the Related Art

A cursor positioning device, such as a mouse or a film positioning device, is widely used in the man-machine interface to facilitate the communication between the user and the electrical device. The film positioning device includes two resistive films or two capacitive films for detecting coordinates of a point contacted by the user.

FIG. 1 shows a circuit diagram of a resistive film positioning device 100, which includes a film 110. The film 110 includes an X film and a Y film. The X film and the Y film are plane resistors and do not contact each other in a natural state. The resistance on the X film varies with the variation of the X coordinate but does not depend on the variation of the Y coordinate. The resistance on the Y film varies with the variation of the Y coordinate but does not depend on the variation of the X coordinate. The film positioning device further includes transistors QX0, QX1, QY0, QY1 and capacitors Cxp, Cxm, Cyp and Cym for detecting a point contacted by a user and isolating the noises, wherein the transistors QX0, QX1, QY0 and QY1 are controlled by signals X0, X1, Y0 and Y1, respectively.

When the user touches the film positioning device 100, the X film is electrically connected to the Y film at a contact point, and the resistor of the contact point is R_touch. In the X film, the resistor above the contact point is R_up, and the resistor below the contact point is R_down. In the Y film, the resistor at the right-hand side of the contact point is R_right, and the resistor at the left-hand side of the contact point is R_left. The film positioning device 100 may obtain the X coordinate of the contact point according to the ratio of the resistor R_up to the resistor R_down, and the Y coordinate of the contact point according to the ratio of the resistor R_right to the resistor R_left.

FIG. 2A shows an equivalent circuit diagram of the film positioning device when the X coordinate of a contact point is detected. When the X coordinate of the contact point is detected, the transistors QY0 and QY1 are turned on, and then the current I1 flows to the ground via QY1, R_left, R_right and QY0. At this time, the X coordinate of the contact point may be obtained by detecting the voltage at the XP point. In addition, the X coordinate of the contact point also may be obtained by detecting the voltage at the XM point.

FIG. 2B shows an equivalent circuit diagram of the film positioning device when the Y coordinate of the contact point is detected. When the Y coordinate of the contact point is detected, the transistors QX0 and QXl are turned on, and then the current I2 flows to the ground via QX1, R_up, R_down and QX0. At this time, the Y coordinate of the contact point may be obtained by detecting the voltage at the YP point. In addition, the Y coordinate of the contact point also may be obtained by detecting the voltage at the YM point.

Because the film positioning device is applied to the electrical device, a lot of noises are often coupled to cause errors in the obtained coordinates. The capacitors Cxp, Cxm, Cyp and Cym are used to isolate noises and ensure the precision of the coordinates. As the capacitances of the capacitors get larger, the capability of isolating noises gets greater, but the response speed of the positioning device gets slower.

As shown in the example of FIG. 2A, when the X coordinate is detected, the capacitor Cyp is charged to about the level of the power source Vcc. When a next coordinate is to be detected, the transistors QY1 and QY2 are turned off, so the capacitor Cyp has to be discharged through the impedances of R_left, R_touch, Cxp, and the like. However, sometimes the force applied from the user to the film positioning device is too small and thus makes the impedance of R_touch very large, thereby lengthening the discharge time of the capacitor Cyp. If the discharge time of the capacitor Cyp is lengthened, the waiting time for the next coordinate to be detected is also lengthened, thereby causing the problem of the insufficiently quick response speed of the positioning device.

Similarly, when the Y coordinate is detected, the capacitor Cxp is charged to about the level of the power source Vcc. If the resistor R_touch is too large, the problem of insufficiently quick response speed of the positioning device owing to the lengthened discharge time will be caused.

Although the response speed of the positioning device may be increased when the capacitances of the capacitors Cxp, Cxm, Cyp and Cym are reduced, the capability for isolating the noises and thus the positioning precision will be deteriorated. It is problematic if the capacitances are enlarged because the response speed of the positioning device will become too slow.

### SUMMARY OF THE INVENTION

It is therefore an object of the invention to provide a film positioning device capable of isolating the noise and increasing the response speed.

The invention achieves the above-identified object by providing a film positioning device for detecting a position of a contact point. The film positioning device includes an X film having a first X terminal and a second X terminal, a Y film having a first Y terminal and a second Y terminal, a first Y switch coupled between the first Y terminal and a ground, a second Y switch coupled between the second Y terminal and the power source, a first X switch coupled between the first X terminal and the ground, a second X switch coupled between the second X terminal and the power source, a first X capacitor coupled between the first X terminal and the second X terminal, and a second Y capacitor coupled between the first Y terminal and the second Y terminal.

Other objects, features, and advantages of the invention will become apparent from the following detailed description of the preferred but non-limiting embodiment. The following description is made with reference to the accompanying drawings.

### BRIEF DESCRIPTION OF THE DRAWINGS

FIG. 1 shows a circuit diagram of a resistive film positioning device.

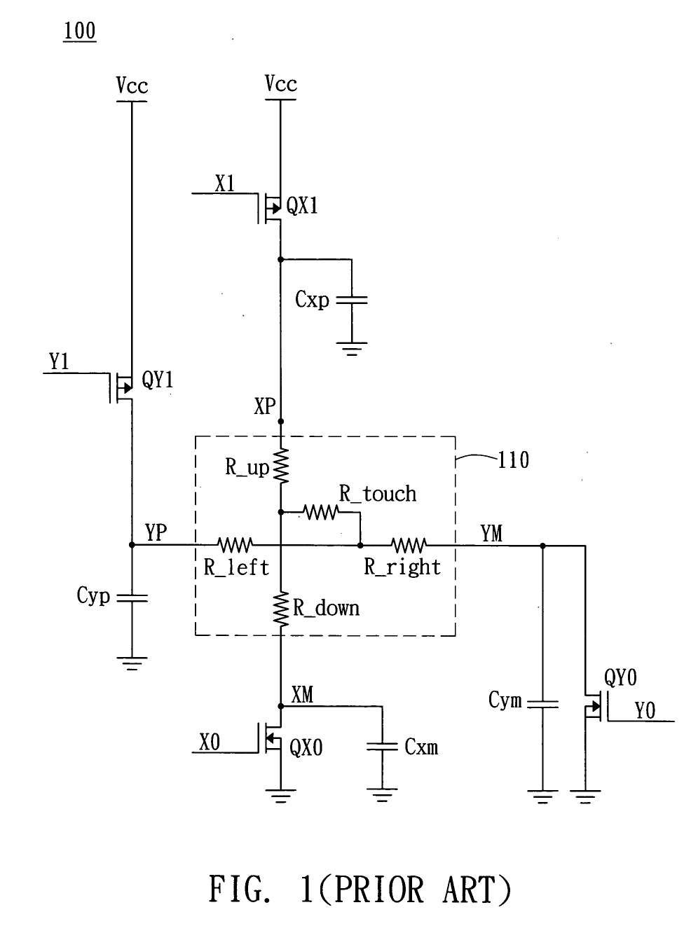

FIG. 2A shows an equivalent circuit diagram of the film positioning device when the X coordinate of a contact point is detected.

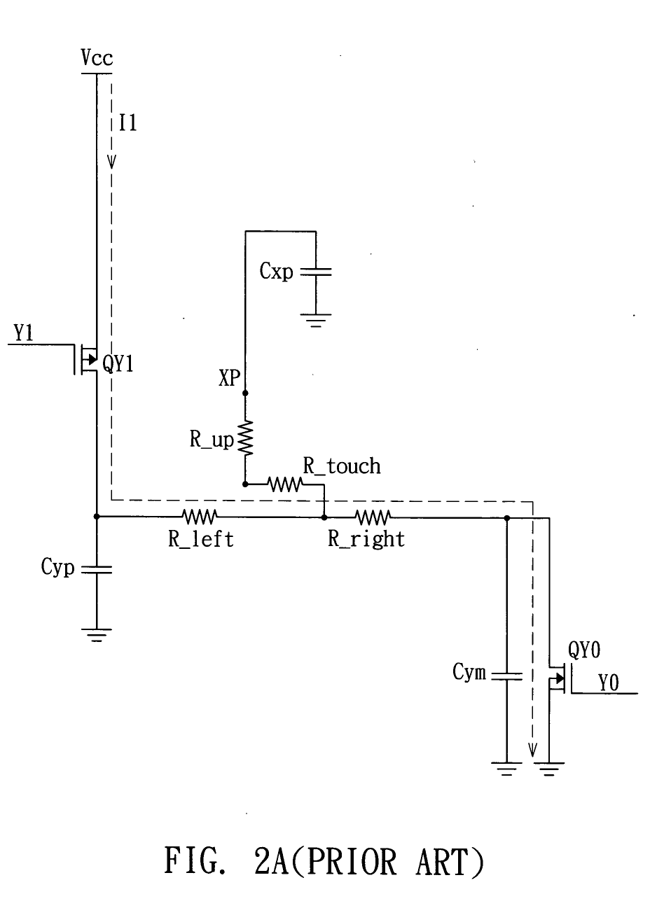

FIG. 2B shows an equivalent circuit diagram of the film positioning device when the Y coordinate of the contact point is detected.

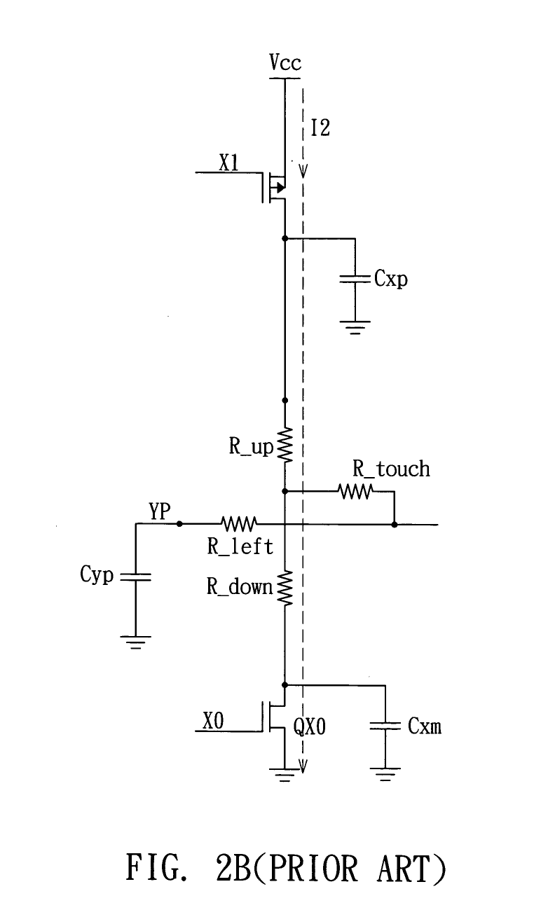

FIG. 3 shows a circuit diagram of a film positioning device according to a preferred embodiment of the invention.

FIG. 4A shows an equivalent circuit diagram of the film positioning device when the X coordinate of the contact point is detected.

FIG. 4B shows an equivalent circuit diagram of the film positioning device when the Y coordinate of the contact point is detected.

### DETAILED DESCRIPTION OF THE INVENTION

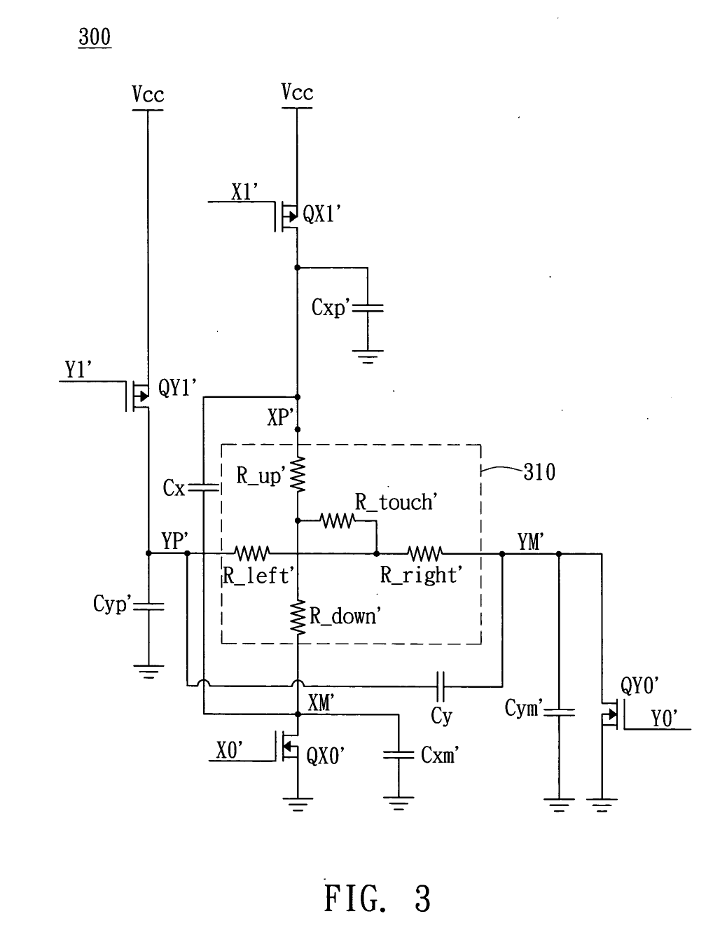

FIG. 3 shows a circuit diagram of a film positioning device according to a preferred embodiment of the invention. The film positioning device 300 includes a film 310, which includes an X film and a Y film. The X film and Y film are plane resistors and do not contact each other in a natural state.

The resistance on the X film varies with the variation of the X coordinate but does not depend on the variation of the Y coordinate. The resistance on the Y film varies with the variation of the Y coordinate but does not depend on the variation of the X coordinate. The film positioning device further includes transistors QX0′, QX1′, QY0′ and QY1′ and capacitors Cx and Cy for detecting a point contacted by a user and isolating the noises, wherein the transistors QX0′, QX1′, QY0′ and QY1′ are controlled by signals X0′, X1′, Y0′ and Y1′, respectively.

When the user touches the film positioning device 300, the X film is electrically connected to the Y film at a contact point, and the resistor of the contact point is R_touch′. In the X film, the resistor above the contact point is R_up′, and the resistor below the contact point is R_down′. In the Y film, the resistor at the right-hand side of the contact point is R_right′, and the resistor at the left-hand side of the contact point is R_left′. The film positioning device 300 may obtain the X coordinate of the contact point according to the ratio of the resistor R_up′ to the resistor R_down′, and the Y coordinate of the contact point according to the ratio of the resistor R_right′ to the resistor R_left′.

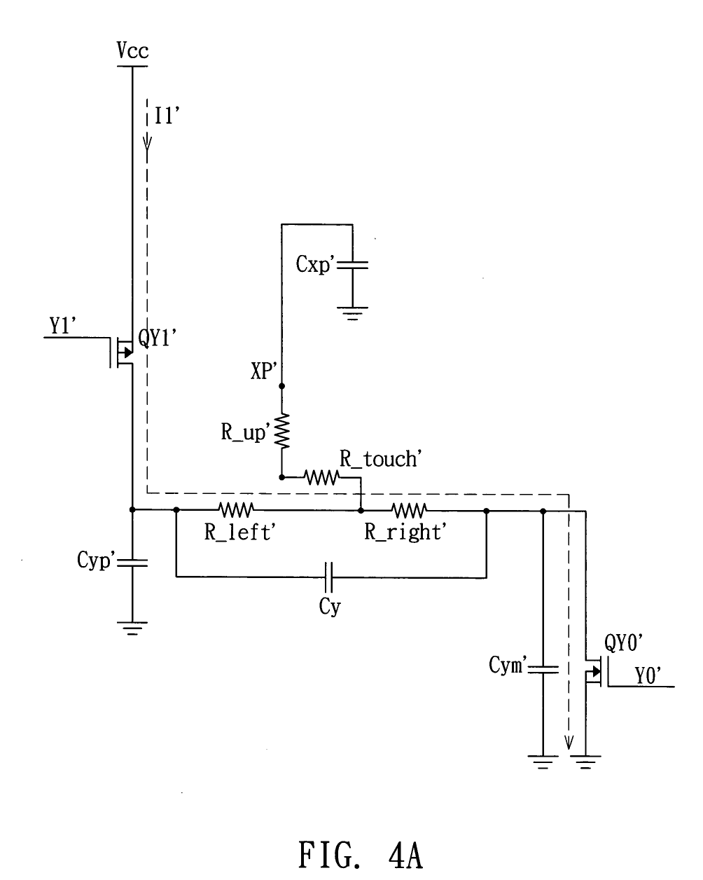

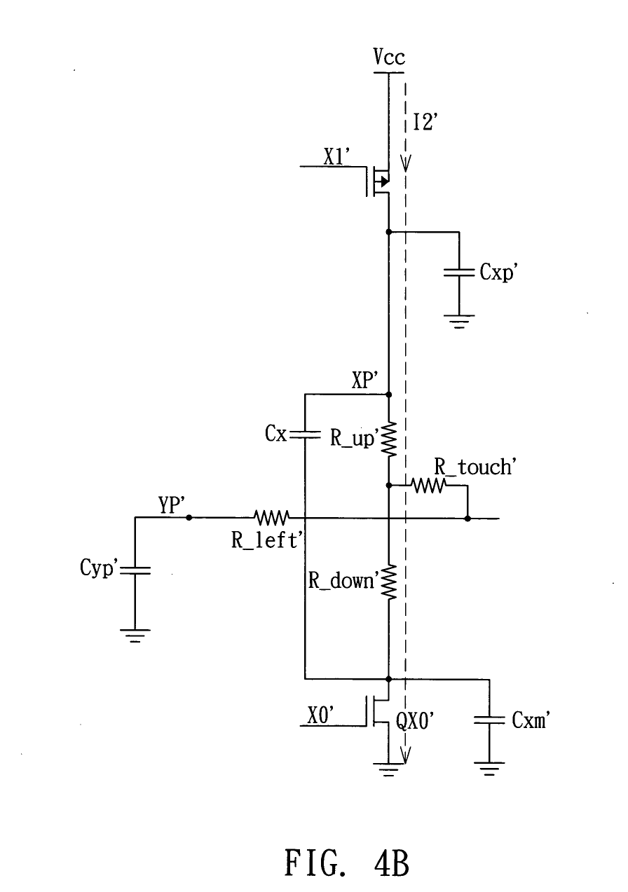

FIG. 4A shows an equivalent circuit diagram of the film positioning device when the X coordinate of the contact point is detected. When the X coordinate of the contact point is detected, the transistors QY0′ and QY1′ are turned on, and then the current I1′ flows to the ground via QY1′, R_left′, R_right′ and QY0′. At this time, the X coordinate of the contact point may be obtained by detecting the voltage at the XP′ point. In addition, the X coordinate of the contact point also may be obtained by detecting the voltage at the XM′ point.

FIG. 4B shows an equivalent circuit diagram of the film positioning device when the Y coordinate of the contact point is detected. When the Y coordinate of the contact point is detected, the transistors QX0′ and QX1′ are turned on, and then the current I2′ flows to the ground via QX1′, R_up′, R_down′ and QX0′. At this time, the Y coordinate of the contact point may be obtained by detecting the voltage at the YP′ point. In addition, the Y coordinate of the contact point also may be obtained by detecting the voltage at the YM′ point.

Because the film positioning device is applied to the electrical device, a lot of noises are often coupled to cause errors in the obtained coordinates. If the film positioning device is applied to, for example, a touch panel of a personal digital assistant (PDA), the caused noise influences will be larger. A liquid crystal display, which has high-frequency signals such as pixel clock signals, horizontal synchronization signals, vertical synchronization signals, and the like so as to maintain an update frequency of, for example, 30 frames per second, is located under the touch panel. The high-frequency signals tend to be coupled to the film positioning device to cause errors in the detected coordinates.

The invention utilizes newly added capacitors Cx and Cy to isolate the noises, and thus to ensure the precision of the coordinates, shorten the discharge time of these capacitors, and increase the response speed of the positioning device 300.

As shown in the example of FIG. 4A, when the X coordinate is detected, the capacitor Cy is charged to about the level of the power source Vcc. When a next coordinate is to be detected, the transistors QY1′ and QY2′ are turned off, so the capacitor Cy may be discharged through the impedances of R_left′ and R_right′ without being discharged through the R_touch′ as performed in the prior art method. Thus, it is possible to avoid the problem of the slow discharge speed caused by the condition when the force supplied by the user is too small and thus makes the impedance of R_touch′ too large.

As similarly shown in the example of FIG. 4B, when the Y coordinate is detected, the capacitor Cx is charged to about the level of the power source Vcc. When a next coordinate is to be detected, the transistors QX1′ and QX2′ are turned off, so the capacitor Cx may be discharged through R_up′ and R_down′ without being discharged through R_touch′ as performed in the prior art method. Thus, it is possible to avoid the problem of the slow discharge speed caused by the condition when the force supplied by the user is too small and thus makes the impedance of R_touch′ too large.

In addition, the embodiment may further include capacitors Cxp′, Cxm′, Cyp′ and Cym′ with smaller capacitances to make the effect against noises better without influencing the response speed of the positioning device.

The disclosed film positioning device according to the embodiment of the invention changes the coupling manner of the capacitors against the noises and makes its discharge time free from being restricted by the magnitude of the impedance of R_touch′, so the positioning speed may be increased and good ability against noises may be obtained.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A film positioning device for detecting a position of a contact point, the device comprising:
an X film having a first X terminal and a second X terminal;
a Y film having a first Y terminal and a second Y terminal;
a first Y switch coupled between the first Y terminal and a ground;
a second Y switch coupled between the second Y terminal and a power source;
a first X switch coupled between the first X terminal and the ground;
a second X switch coupled between the second X terminal and the power source;
a first X capacitor coupled between the first X terminal and the second X terminal; and
a second Y capacitor coupled between the first Y terminal and the second Y terminal;
wherein when the film positioning device detects an X coordinate of the contact point, the first Y switch and the second Y switch are turned on, and then the X coordinate is obtained according to a voltage at the first X terminal or the second X terminal;
wherein when the film positioning device detects a Y coordinate of the contact point, the first X switch and the second X switch are turned on, and then the Y coordinate is obtained according to a voltage at the first Y terminal or the second Y terminal.

2. The film positioning device according to claim 1, wherein the X film and the Y film are plane resistors.

3. The film positioning device according to claim 1, wherein the first Y switch, the second Y switch, the first X switch and the second X switch are transistors.

4. The film positioning device according to claim 1, further comprising:
a first capacitor coupled to the first X terminal;
a second capacitor coupled to the second X terminal;
a third capacitor coupled to the first Y terminal; and
a fourth capacitor coupled to the second Y terminal.
